(19) United States
(12) Patent Application Publication
(10) Pub. No.: US 2024/0037156 A1
(43) Pub. Date: Feb. 1, 2024

(54) INTEGRATING MULTIPLE SHARED DOCUMENTS

(71) Applicant: Zoom Video Communications, Inc., San Jose, CA (US)

(72) Inventor: Robert Allen RYSKAMP, Mountain View, CA (US)

(73) Assignee: Zoom Video Communications, Inc., San Jose, CA (US)

(21) Appl. No.: 17/874,871

(22) Filed: Jul. 27, 2022

(51) Int. Cl. G06F 16/93

(52) U.S. Cl. CPC G06F 16/93

(57) ABSTRACT

One example method includes associating a plurality of documents with a project, each document of the plurality of document having an associated status; generating a project status based on the status of each document of the plurality of documents; receiving an updated status of a first document; adjusting the project status based on the updated status; and in response to the updated project status meeting a threshold, providing a notification of the project status.

### FIELD

The present application generally relates to shared digital documents and more particularly relates to integrating multiple shared documents.

### BRIEF DESCRIPTION OF THE DRAWINGS

The accompanying drawings, which are incorporated into and constitute a part of this specification, illustrate one or more certain examples and, together with the description of the example, serve to explain the principles and implementations of the certain examples.

FIGS. 1-2 show example systems for integrating multiple shared documents;

FIGS. 3A-3C show an example system for integrating multiple shared documents;

FIGS. 4A-4G and 5 show views of example graphical user interfaces for integrating multiple shared documents;

FIG. 6 shows example methods for integrating multiple shared documents; and

FIG. 7 shows an example computing device suitable for systems and methods for integrating multiple shared documents.

### DETAILED DESCRIPTION

Examples are described herein in the context of integrating multiple shared documents. Those of ordinary skill in the art will realize that the following description is illustrative only and is not intended to be in any way limiting. Reference will now be made in detail to implementations of examples as illustrated in the accompanying drawings. The same reference indicators will be used throughout the drawings and the following description to refer to the same or like items.

In the interest of clarity, not all of the routine features of the examples described herein are shown and described. It will, of course, be appreciated that in the development of any such actual implementation, numerous implementation-specific decisions must be made in order to achieve the developer's specific goals, such as compliance with application- and business-related constraints, and that these specific goals will vary from one implementation to another and from one developer to another.

As a part of working on various teams, people may collaborate when creating and editing documents. For example, engineering teams may jointly develop design documents or specifications, marketing teams may generate presentations or product mockups, and management teams may create roadmaps or business strategies or goals. And while each of these documents is stored independently from each of the others and can be independently shared and modified, in many cases the documents themselves are related to each other, such as by virtue of being part of the same project or overarching goal. Further, these projects or goals may further be related to a higher-order project or goal. For example, an engineering team may design a component for a product that is, in turn, a component of another product.

However, because the documents are each treated as discrete and self-contained, it can be difficult to understand how the documents relate to each other and to understand whether progress is being made towards the goals represented by the documents. To enable documents to be related to each other, a system may provide an document integration system that allows a user to identify one or more documents that each relate to a common project or goal. The system stores the relations between the documents and provides a graphical user interface (“GUI”) to view the associated documents and the current status of the project or goal. As content is incorporated into the various documents, reviews and approvals are provided, and documents are completed, information from the individual documents can be obtained based on the relations and used to update the status. Moreover, the information can be used to initiate different processes necessary to the project or goal, such as reviews or approvals. A user can then access the GUI to view the current status of the project or goal and, if interested, identify potential issues, such as aspects of the project or goal that have not been started, or needed actions, such as reviews or approvals.

Virtual conference providers are increasingly providing more comprehensive collaboration and communication capabilities beyond video and audio conferencing. For example, virtual conference providers provide online virtual whiteboards for use in meetings and virtual spaces within which users may virtually meet, maintain and collaborate on documents, and engage in impromptu interactions, all while remote from each other. Thus, a virtual conference provider may provide such integrating multiple shared documents into the products and services it offers its clients. Such a system can provide document integration that allows easier detection of roadblocks or other issues that might arise during the course of a project or working towards a goal. In addition, it can enable initiation of different actions to address those identified issues.

This illustrative example is given to introduce the reader to the general subject matter discussed herein and the disclosure is not limited to this example. The following sections describe various additional non-limiting examples and examples of integrating multiple shared documents.

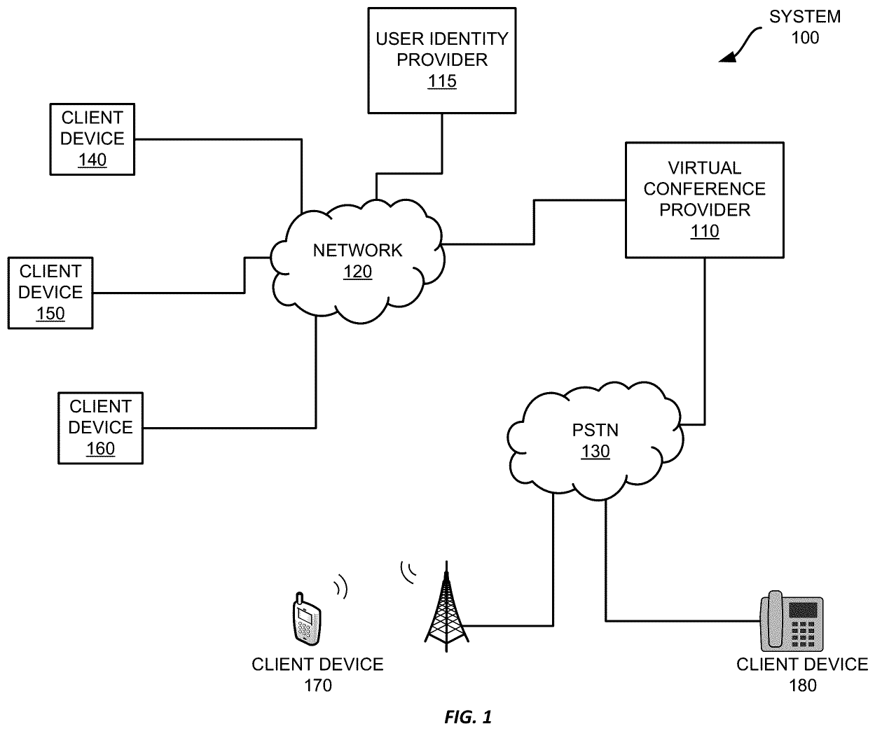

Referring now to FIG. 1, FIG. 1 shows an example system 100 that provides videoconferencing functionality to various client devices. The system 100 includes a virtual conference provider 110 that is connected to multiple communication networks 120, 130, through which various client devices 140-180 can participate in virtual conferences hosted by the virtual conference provider 110. For example, the virtual conference provider 110 can be located within a private network to provide video conferencing services to devices within the private network, or it can be connected to a public network, e.g., the internet, so it may be accessed by anyone. Some examples may even provide a hybrid model in which a virtual conference provider 110 may supply components to enable a private organization to host private internal virtual conferences or to connect its system to the virtual conference provider 110 over a public network.

The system optionally also includes one or more user identity providers, e.g., user identity provider 115, which can provide user identity services to users of the client devices 140-160 and may authenticate user identities of one or more users to the virtual conference provider 110. In this example, the user identity provider 115 is operated by a different entity than the virtual conference provider 110, though in some examples, they may be the same entity.

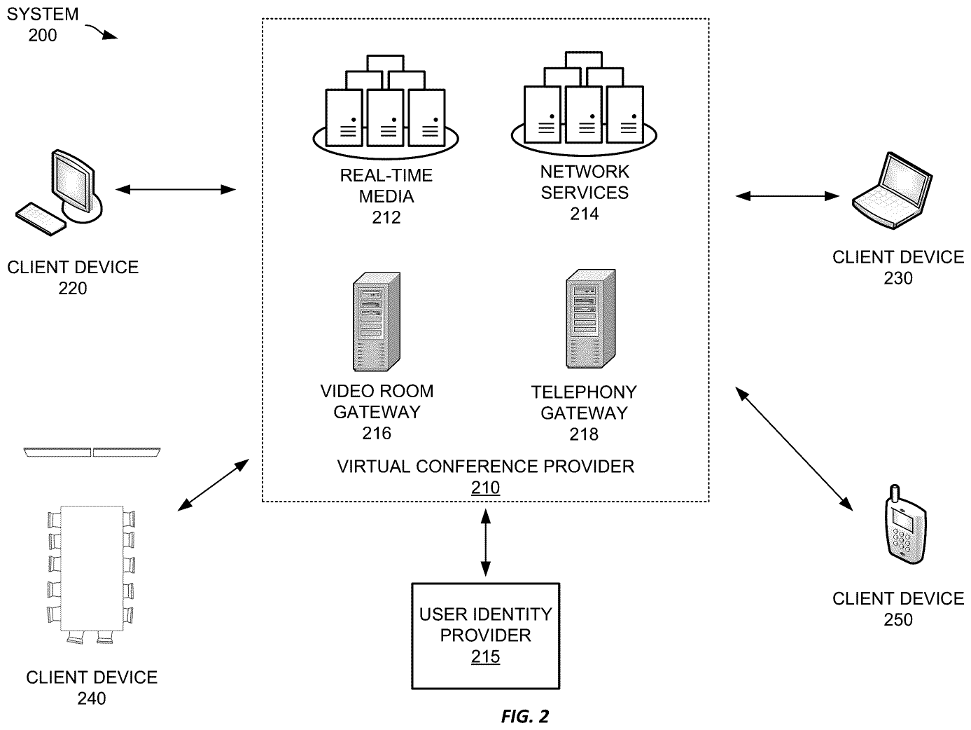

Virtual conference provider 110 allows clients to create videoconference meetings (or “meetings”) and invite others to participate in those meetings as well as perform other related functionality, such as recording the meetings, generating transcripts from meeting audio, manage user functionality in the meetings, enable text messaging during the meetings, create and manage breakout rooms from the main meeting, etc. FIG. 2, described below, provides a more detailed description of the architecture and functionality of the virtual conference provider 110.

Meetings in this example virtual conference provider 110 are provided in virtual “rooms” to which participants are connected. The room in this context is a construct provided by a server that provides a common point at which the various video and audio data is received before being multiplexed and provided to the various participants. While a “room” is the label for this concept in this disclosure, any suitable functionality that enables multiple participants to participate in a common videoconference may be used. Further, in some examples, and as alluded to above, a meeting may also have “breakout” rooms. Such breakout rooms may also be rooms that are associated with a “main” videoconference room. Thus, participants in the main videoconference room may exit the room into a breakout room, e.g., to discuss a particular topic, before returning to the main room. The breakout rooms in this example are discrete meetings that are associated with the meeting in the main room. However, to join a breakout room, a participant must first enter the main room. A room may have any number of associated breakout rooms according to various examples.

To create a meeting with the virtual conference provider 110, a user may contact the virtual conference provider 110 using a client device 140-180 and select an option to create a new meeting. Such an option may be provided in a webpage accessed by a client device 140-160 or client application executed by a client device 140-160. For telephony devices, the user may be presented with an audio menu that they may navigate by pressing numeric buttons on their telephony device. To create the meeting, the virtual conference provider 110 may prompt the user for certain information, such as a date, time, and duration for the meeting, a number of participants, a type of encryption to use, whether the meeting is confidential or open to the public, etc. After receiving the various meeting settings, the virtual conference provider may create a record for the meeting and generate a meeting identifier and, in some examples, a corresponding meeting password or passcode (or other authentication information), all of which meeting information is provided to the meeting host.

After receiving the meeting information, the user may distribute the meeting information to one or more users to invite them to the meeting. To begin the meeting at the scheduled time (or immediately, if the meeting was set for an immediate start), the host provides the meeting identifier and, if applicable, corresponding authentication information (e.g., a password or passcode). The virtual conference system then initiates the meeting and may admit users to the meeting. Depending on the options set for the meeting, the users may be admitted immediately upon providing the appropriate meeting identifier (and authentication information, as appropriate), even if the host has not yet arrived, or the users may be presented with information indicating that the meeting has not yet started or the host may be required to specifically admit one or more of the users.

During the meeting, the participants may employ their client devices 140-180 to capture audio or video information and stream that information to the virtual conference provider 110. They also receive audio or video information from the virtual conference provider 110, which is displayed by the respective client device 140 to enable the various users to participate in the meeting.

At the end of the meeting, the host may select an option to terminate the meeting, or it may terminate automatically at a scheduled end time or after a predetermined duration. When the meeting terminates, the various participants are disconnected from the meeting and they will no longer receive audio or video streams for the meeting (and will stop transmitting audio or video streams). The virtual conference provider 110 may also invalidate the meeting information, such as the meeting identifier or password/passcode.

To provide such functionality, one or more client devices 140-180 may communicate with the virtual conference provider 110 using one or more communication networks, such as network 120 or the public switched telephone network (“PSTN”) 130. The client devices 140-180 may be any suitable computing or communications device that have audio or video capability. For example, client devices 140-160 may be conventional computing devices, such as desktop or laptop computers having processors and computer-readable media, connected to the virtual conference provider 110 using the internet or other suitable computer network. Suitable networks include the internet, any local area network (“LAN”), metro area network (“MAN”), wide area network (“WAN”), cellular network (e.g., 3G, 4G, 4G LTE, 5G, etc.), or any combination of these. Other types of computing devices may be used instead or as well, such as tablets, smartphones, and dedicated video conferencing equipment. Each of these devices may provide both audio and video capabilities and may enable one or more users to participate in a virtual conference meeting hosted by the virtual conference provider 110.

In addition to the computing devices discussed above, client devices 140-180 may also include one or more telephony devices, such as cellular telephones (e.g., cellular telephone 170), internet protocol (“IP”) phones (e.g., telephone 180), or conventional telephones. Such telephony devices may allow a user to make conventional telephone calls to other telephony devices using the PSTN, including the virtual conference provider 110. It should be appreciated that certain computing devices may also provide telephony functionality and may operate as telephony devices. For example, smartphones typically provide cellular telephone capabilities and thus may operate as telephony devices in the example system 100 shown in FIG. 1. In addition, conventional computing devices may execute software to enable telephony functionality, which may allow the user to make and receive phone calls, e.g., using a headset and microphone. Such software may communicate with a PSTN gateway to route the call from a computer network to the PSTN. Thus, telephony devices encompass any devices that can make conventional telephone calls and is not limited solely to dedicated telephony devices like conventional telephones.

Referring again to client devices 140-160, these devices 140-160 contact the virtual conference provider 110 using network 120 and may provide information to the virtual conference provider 110 to access functionality provided by the virtual conference provider 110, such as access to create new meetings or join existing meetings. To do so, the client devices 140-160 may provide user identification information, meeting identifiers, meeting passwords or passcodes, etc. In examples that employ a user identity provider 115, a client device, e.g., client devices 140-160, may operate in conjunction with a user identity provider 115 to provide user identification information or other user information to the virtual conference provider 110.

A user identity provider 115 may be any entity trusted by the virtual conference provider 110 that can help identify a user to the virtual conference provider 110. For example, a trusted entity may be a server operated by a business or other organization and with whom the user has established their identity, such as an employer or trusted third-party. The user may sign into the user identity provider 115, such as by providing a username and password, to access their identity at the user identity provider 115. The identity, in this sense, is information established and maintained at the user identity provider 115 that can be used to identify a particular user, irrespective of the client device they may be using. An example of an identity may be an email account established at the user identity provider 110 by the user and secured by a password or additional security features, such as biometric authentication, two-factor authentication, etc. However, identities may be distinct from functionality such as email. For example, a health care provider may establish identities for its patients. And while such identities may have associated email accounts, the identity is distinct from those email accounts. Thus, a user's “identity” relates to a secure, verified set of information that is tied to a particular user and should be accessible only by that user. By accessing the identity, the associated user may then verify themselves to other computing devices or services, such as the virtual conference provider 110.

When the user accesses the virtual conference provider 110 using a client device, the virtual conference provider 110 communicates with the user identity provider 115 using information provided by the user to verify the user's identity. For example, the user may provide a username or cryptographic signature associated with a user identity provider 115. The user identity provider 115 then either confirms the user's identity or denies the request. Based on this response, the virtual conference provider 110 either provides or denies access to its services, respectively.

For telephony devices, e.g., client devices 170-180, the user may place a telephone call to the virtual conference provider 110 to access virtual conference services. After the call is answered, the user may provide information regarding a virtual conference meeting, e.g., a meeting identifier (“ID”), a passcode or password, etc., to allow the telephony device to join the meeting and participate using audio devices of the telephony device, e.g., microphone(s) and speaker(s), even if video capabilities are not provided by the telephony device.

Because telephony devices typically have more limited functionality than conventional computing devices, they may be unable to provide certain information to the virtual conference provider 110. For example, telephony devices may be unable to provide user identification information to identify the telephony device or the user to the virtual conference provider 110. Thus, the virtual conference provider 110 may provide more limited functionality to such telephony devices. For example, the user may be permitted to join a meeting after providing meeting information, e.g., a meeting identifier and passcode, but they may be identified only as an anonymous participant in the meeting. This may restrict their ability to interact with the meetings in some examples, such as by limiting their ability to speak in the meeting, hear or view certain content shared during the meeting, or access other meeting functionality, such as joining breakout rooms or engaging in text chat with other participants in the meeting.

It should be appreciated that users may choose to participate in meetings anonymously and decline to provide user identification information to the virtual conference provider 110, even in cases where the user has an authenticated identity and employs a client device capable of identifying the user to the virtual conference provider 110. The virtual conference provider 110 may determine whether to allow such anonymous users to use services provided by the virtual conference provider 110. Anonymous users, regardless of the reason for anonymity, may be restricted as discussed above with respect to users employing telephony devices, and in some cases may be prevented from accessing certain meetings or other services, or may be entirely prevented from accessing the virtual conference provider 110.

Referring again to virtual conference provider 110, in some examples, it may allow client devices 140-160 to encrypt their respective video and audio streams to help improve privacy in their meetings. Encryption may be provided between the client devices 140-160 and the virtual conference provider 110 or it may be provided in an end-to-end configuration where multimedia streams transmitted by the client devices 140-160 are not decrypted until they are received by another client device 140-160 participating in the meeting. Encryption may also be provided during only a portion of a communication, for example encryption may be used for otherwise unencrypted communications that cross international borders.

Client-to-server encryption may be used to secure the communications between the client devices 140-160 and the virtual conference provider 110, while allowing the virtual conference provider 110 to access the decrypted multimedia streams to perform certain processing, such as recording the meeting for the participants or generating transcripts of the meeting for the participants. End-to-end encryption may be used to keep the meeting entirely private to the participants without any worry about a virtual conference provider 110 having access to the substance of the meeting. Any suitable encryption methodology may be employed, including key-pair encryption of the streams. For example, to provide end-to-end encryption, the meeting host's client device may obtain public keys for each of the other client devices participating in the meeting and securely exchange a set of keys to encrypt and decrypt multimedia content transmitted during the meeting. Thus the client devices 140-160 may securely communicate with each other during the meeting. Further, in some examples, certain types of encryption may be limited by the types of devices participating in the meeting. For example, telephony devices may lack the ability to encrypt and decrypt multimedia streams. Thus, while encrypting the multimedia streams may be desirable in many instances, it is not required as it may prevent some users from participating in a meeting.

By using the example system shown in FIG. 1, users can create and participate in meetings using their respective client devices 140-180 via the virtual conference provider 110. Further, such a system enables users to use a wide variety of different client devices 140-180 from traditional standards-based video conferencing hardware to dedicated video conferencing equipment to laptop or desktop computers to handheld devices to legacy telephony devices, etc.

Referring now to FIG. 2, FIG. 2 shows an example system 200 in which a virtual conference provider 210 provides videoconferencing functionality to various client devices 220-250. The client devices 220-250 include two conventional computing devices 220-230, dedicated equipment for a video conference room 240, and a telephony device 250. Each client device 220-250 communicates with the virtual conference provider 210 over a communications network, such as the internet for client devices 220-240 or the PSTN for client device 250, generally as described above with respect to FIG. 1. The virtual conference provider 210 is also in communication with one or more user identity providers 215, which can authenticate various users to the virtual conference provider 210 generally as described above with respect to FIG. 1.

In this example, the virtual conference provider 210 employs multiple different servers (or groups of servers) to provide different aspects of virtual conference functionality, thereby enabling the various client devices to create and participate in virtual conference meetings. The virtual conference provider 210 uses one or more real-time media servers 212, one or more network services servers 214, one or more video room gateways 216, and one or more telephony gateways 218. Each of these servers 212-218 is connected to one or more communications networks to enable them to collectively provide access to and participation in one or more virtual conference meetings to the client devices 220-250.

The real-time media servers 212 provide multiplexed multimedia streams to meeting participants, such as the client devices 220-250 shown in FIG. 2. While video and audio streams typically originate at the respective client devices, they are transmitted from the client devices 220-250 to the virtual conference provider 210 via one or more networks where they are received by the real-time media servers 212. The real-time media servers 212 determine which protocol is optimal based on, for example, proxy settings and the presence of firewalls, etc. For example, the client device might select among UDP, TCP, TLS, or HTTPS for audio and video and UDP for content screen sharing.

The real-time media servers 212 then multiplex the various video and audio streams based on the target client device and communicate multiplexed streams to each client device. For example, the real-time media servers 212 receive audio and video streams from client devices 220-240 and only an audio stream from client device 250. The real-time media servers 212 then multiplex the streams received from devices 230-250 and provide the multiplexed streams to client device 220. The real-time media servers 212 are adaptive, for example, reacting to real-time network and client changes, in how they provide these streams. For example, the real-time media servers 212 may monitor parameters such as a client's bandwidth CPU usage, memory and network I/O as well as network parameters such as packet loss, latency and jitter to determine how to modify the way in which streams are provided.

The client device 220 receives the stream, performs any decryption, decoding, and demultiplexing on the received streams, and then outputs the audio and video using the client device's video and audio devices. In this example, the real-time media servers do not multiplex client device 220's own video and audio feeds when transmitting streams to it. Instead each client device 220-250 only receives multimedia streams from other client devices 220-250. For telephony devices that lack video capabilities, e.g., client device 250, the real-time media servers 212 only deliver multiplex audio streams. The client device 220 may receive multiple streams for a particular communication, allowing the client device 220 to switch between streams to provide a higher quality of service.

In addition to multiplexing multimedia streams, the real-time media servers 212 may also decrypt incoming multimedia stream in some examples. As discussed above, multimedia streams may be encrypted between the client devices 220-250 and the virtual conference system 210. In some such examples, the real-time media servers 212 may decrypt incoming multimedia streams, multiplex the multimedia streams appropriately for the various clients, and encrypt the multiplexed streams for transmission.

In some examples, to provide multiplexed streams, the virtual conference provider 210 may receive multimedia streams from the various participants and publish those streams to the various participants to subscribe to and receive. Thus, the virtual conference provider 210 notifies a client device, e.g., client device 220, about various multimedia streams available from the other client devices 230-250, and the client device 220 can select which multimedia stream(s) to subscribe to and receive. In some examples, the virtual conference provider 210 may provide to each client device the available streams from the other client devices, but from the respective client device itself, though in other examples it may provide all available streams to all available client devices. Using such a multiplexing technique, the virtual conference provider 210 may enable multiple different streams of varying quality, thereby allowing client devices to change streams in real-time as needed, e.g., based on network bandwidth, latency, etc.

As mentioned above with respect to FIG. 1, the virtual conference provider 210 may provide certain functionality with respect to unencrypted multimedia streams at a user's request. For example, the meeting host may be able to request that the meeting be recorded or that a transcript of the audio streams be prepared, which may then be performed by the real-time media servers 212 using the decrypted multimedia streams, or the recording or transcription functionality may be off-loaded to a dedicated server (or servers), e.g., cloud recording servers, for recording the audio and video streams. In some examples, the virtual conference provider 210 may allow a meeting participant to notify it of inappropriate behavior or content in a meeting. Such a notification may trigger the real-time media servers to 212 record a portion of the meeting for review by the virtual conference provider 210. Still other functionality may be implemented to take actions based on the decrypted multimedia streams at the virtual conference provider 210, such as monitoring video or audio quality, adjusting or changing media encoding mechanisms, etc.

It should be appreciated that multiple real-time media servers 212 may be involved in communicating data for a single meeting and multimedia streams may be routed through multiple different real-time media servers 212. In addition, the various real-time media servers 212 may not be co-located, but instead may be located at multiple different geographic locations, which may enable high-quality communications between clients that are dispersed over wide geographic areas, such as being located in different countries or on different continents. Further, in some examples, one or more of these servers may be co-located on a client's premises, e.g., at a business or other organization. For example, different geographic regions may each have one or more real-time media servers 212 to enable client devices in the same geographic region to have a high-quality connection into the virtual conference provider 210 via local servers 212 to send and receive multimedia streams, rather than connecting to a real-time media server located in a different country or on a different continent. The local real-time media servers 212 may then communicate with physically distant servers using high-speed network infrastructure, e.g., internet backbone network(s), that otherwise might not be directly available to client devices 220-250 themselves. Thus, routing multimedia streams may be distributed throughout the virtual conference system 210 and across many different real-time media servers 212.

Turning to the network services servers 214, these servers 214 provide administrative functionality to enable client devices to create or participate in meetings, send meeting invitations, create or manage user accounts or subscriptions, and other related functionality. Further, these servers may be configured to perform different functionalities or to operate at different levels of a hierarchy, e.g., for specific regions or localities, to manage portions of the virtual conference provider 210 under a supervisory set of servers. When a client device 220-250 accesses the virtual conference provider 210, it will typically communicate with one or more network services servers 214 to access their account or to participate in a meeting.

When a client device 220-250 first contacts the virtual conference provider 210 in this example, it is routed to a network services server 214. The client device may then provide access credentials for a user, e.g., a username and password or single sign-on credentials, to gain authenticated access to the virtual conference provider 210. This process may involve the network services servers 214 contacting a user identity provider 215 to verify the provided credentials. Once the user's credentials have been accepted, the client device 214 may perform administrative functionality, like updating user account information, if the user has an identity with the virtual conference provider 210, or scheduling a new meeting, by interacting with the network services servers 214.

In some examples, users may access the virtual conference provider 210 anonymously. When communicating anonymously, a client device 220-250 may communicate with one or more network services servers 214 but only provide information to create or join a meeting, depending on what features the virtual conference provider 210 allows for anonymous users. For example, an anonymous user may access the virtual conference provider using client 220 and provide a meeting ID and passcode. The network services server 214 may use the meeting ID to identify an upcoming or on-going meeting and verify the passcode is correct for the meeting ID. After doing so, the network services server(s) 214 may then communicate information to the client device 220 to enable the client device 220 to join the meeting and communicate with appropriate real-time media servers 212.

In cases where a user wishes to schedule a meeting, the user (anonymous or authenticated) may select an option to schedule a new meeting and may then select various meeting options, such as the date and time for the meeting, the duration for the meeting, a type of encryption to be used, one or more users to invite, privacy controls (e.g., not allowing anonymous users, preventing screen sharing, manually authorize admission to the meeting, etc.), meeting recording options, etc. The network services servers 214 may then create and store a meeting record for the scheduled meeting. When the scheduled meeting time arrives (or within a threshold period of time in advance), the network services server(s) 214 may accept requests to join the meeting from various users.

To handle requests to join a meeting, the network services server(s) 214 may receive meeting information, such as a meeting ID and passcode, from one or more client devices 220-250. The network services server(s) 214 locate a meeting record corresponding to the provided meeting ID and then confirm whether the scheduled start time for the meeting has arrived, whether the meeting host has started the meeting, and whether the passcode matches the passcode in the meeting record. If the request is made by the host, the network services server(s) 214 activates the meeting and connects the host to a real-time media server 212 to enable the host to begin sending and receiving multimedia streams.

Once the host has started the meeting, subsequent users requesting access will be admitted to the meeting if the meeting record is located and the passcode matches the passcode supplied by the requesting client device 220-250. In some examples additional access controls may be used as well. But if the network services server(s) 214 determines to admit the requesting client device 220-250 to the meeting, the network services server 214 identifies a real-time media server 212 to handle multimedia streams to and from the requesting client device 220-250 and provides information to the client device 220-250 to connect to the identified real-time media server 212. Additional client devices 220-250 may be added to the meeting as they request access through the network services server(s) 214.

After joining a meeting, client devices will send and receive multimedia streams via the real-time media servers 212, but they may also communicate with the network services servers 214 as needed during meetings. For example, if the meeting host leaves the meeting, the network services server(s) 214 may appoint another user as the new meeting host and assign host administrative privileges to that user. Hosts may have administrative privileges to allow them to manage their meetings, such as by enabling or disabling screen sharing, muting or removing users from the meeting, creating sub-meetings or “break-out” rooms, recording meetings, etc. Such functionality may be managed by the network services server(s) 214.

For example, if a host wishes to remove a user from a meeting, they may identify the user and issue a command through a user interface on their client device. The command may be sent to a network services server 214, which may then disconnect the identified user from the corresponding real-time media server 212. If the host wishes to create a break-out room for one or more meeting participants to join, such a command may also be handled by a network services server 214, which may create a new meeting record corresponding to the break-out room and then connect one or more meeting participants to the break-out room similarly to how it originally admitted the participants to the meeting itself.

In addition to creating and administering on-going meetings, the network services server(s) 214 may also be responsible for closing and tearing-down meetings once they have completed. For example, the meeting host may issue a command to end an on-going meeting, which is sent to a network services server 214. The network services server 214 may then remove any remaining participants from the meeting, communicate with one or more real time media servers 212 to stop streaming audio and video for the meeting, and deactivate, e.g., by deleting a corresponding passcode for the meeting from the meeting record, or delete the meeting record(s) corresponding to the meeting. Thus, if a user later attempts to access the meeting, the network services server(s) 214 may deny the request.

Depending on the functionality provided by the virtual conference provider, the network services server(s) 214 may provide additional functionality, such as by providing private meeting capabilities for organizations, special types of meetings (e.g., webinars), etc. Such functionality may be provided according to various examples of video conferencing providers according to this description.

Referring now to the video room gateway servers 216, these servers 216 provide an interface between dedicated video conferencing hardware, such as may be used in dedicated video conferencing rooms. Such video conferencing hardware may include one or more cameras and microphones and a computing device designed to receive video and audio streams from each of the cameras and microphones and connect with the virtual conference provider 210. For example, the video conferencing hardware may be provided by the virtual conference provider 210 to one or more of its subscribers, which may provide access credentials to the video conferencing hardware to use to connect to the virtual conference provider 210.

The video room gateway servers 216 provide specialized authentication and communication with the dedicated video conferencing hardware that may not be available to other client devices 220-230, 250. For example, the video conferencing hardware may register with the virtual conference provider 210 when it is first installed and the video room gateway servers 216 may authenticate the video conferencing hardware using such registration as well as information provided to the video room gateway server(s) 216 when dedicated video conferencing hardware connects to it, such as device ID information, subscriber information, hardware capabilities, hardware version information etc. Upon receiving such information and authenticating the dedicated video conferencing hardware, the video room gateway server(s) 216 may interact with the network services servers 214 and real-time media servers 212 to allow the video conferencing hardware to create or join meetings hosted by the virtual conference provider 210.

Referring now to the telephony gateway servers 218, these servers 218 enable and facilitate telephony devices' participation in meetings hosed by the virtual conference provider 210. Because telephony devices communicate using the PSTN and not using computer networking protocols, such as TCP/IP, the telephony gateway servers 218 act as an interface that converts between the PSTN and the networking system used by the virtual conference provider 210.

For example, if a user uses a telephony device to connect to a meeting, they may dial a phone number corresponding to one of the virtual conference provider's telephony gateway servers 218. The telephony gateway server 218 will answer the call and generate audio messages requesting information from the user, such as a meeting ID and passcode. The user may enter such information using buttons on the telephony device, e.g., by sending dual-tone multi-frequency (“DTMF”) audio signals to the telephony gateway server 218. The telephony gateway server 218 determines the numbers or letters entered by the user and provides the meeting ID and passcode information to the network services servers 214, along with a request to join or start the meeting, generally as described above. Once the telephony client device 250 has been accepted into a meeting, the telephony gateway server 218 is instead joined to the meeting on the telephony device's behalf.

After joining the meeting, the telephony gateway server 218 receives an audio stream from the telephony device and provides it to the corresponding real-time media server 212, and receives audio streams from the real-time media server 212, decodes them, and provides the decoded audio to the telephony device. Thus, the telephony gateway servers 218 operate essentially as client devices, while the telephony device operates largely as an input/output device, e.g., a microphone and speaker, for the corresponding telephony gateway server 218, thereby enabling the user of the telephony device to participate in the meeting despite not using a computing device or video.

It should be appreciated that the components of the virtual conference provider 210 discussed above are merely examples of such devices and an example architecture. Some virtual conference providers may provide more or less functionality than described above and may not separate functionality into different types of servers as discussed above. Instead, any suitable servers and network architectures may be used according to different examples.

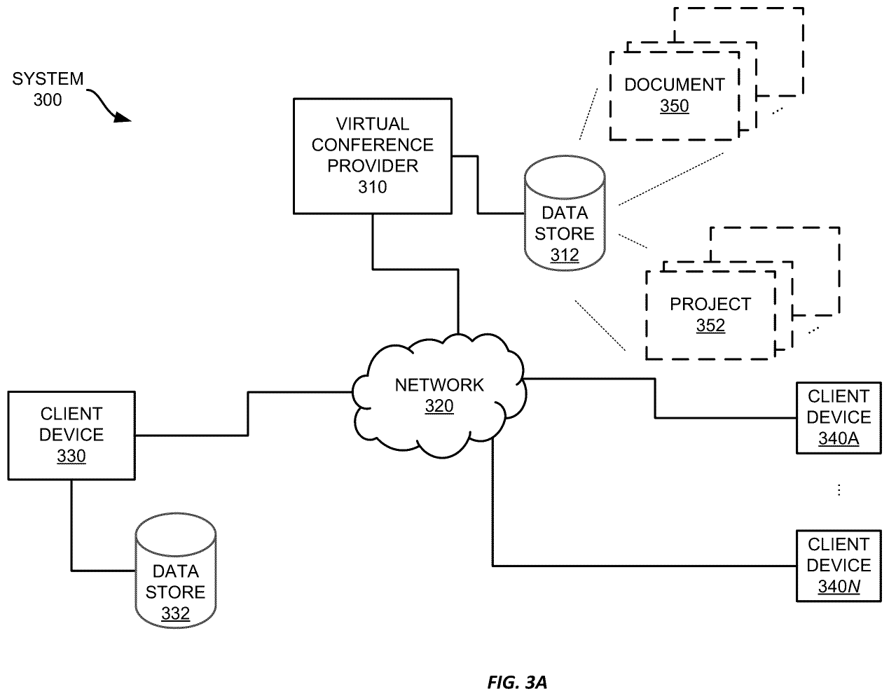

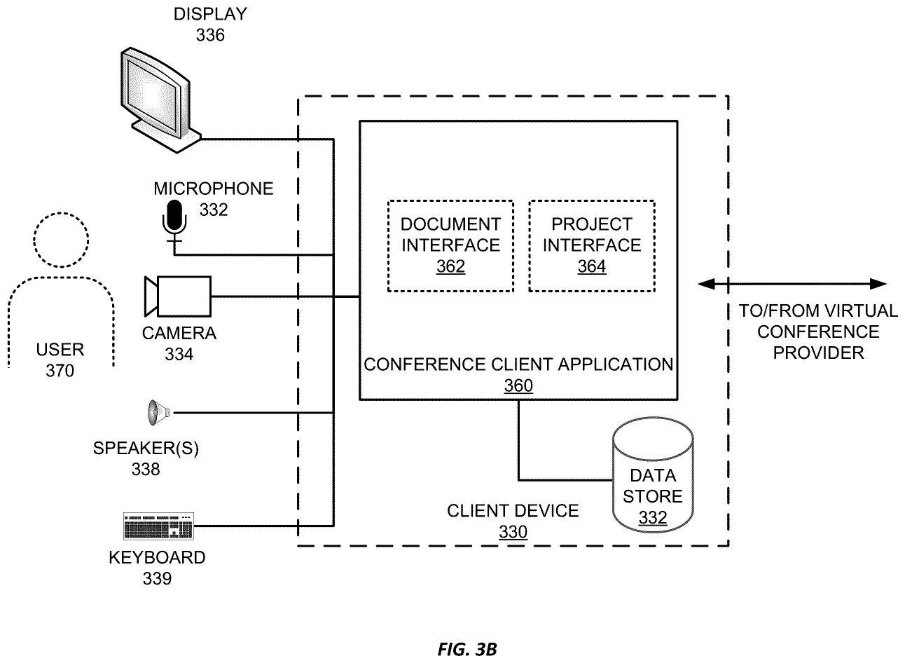

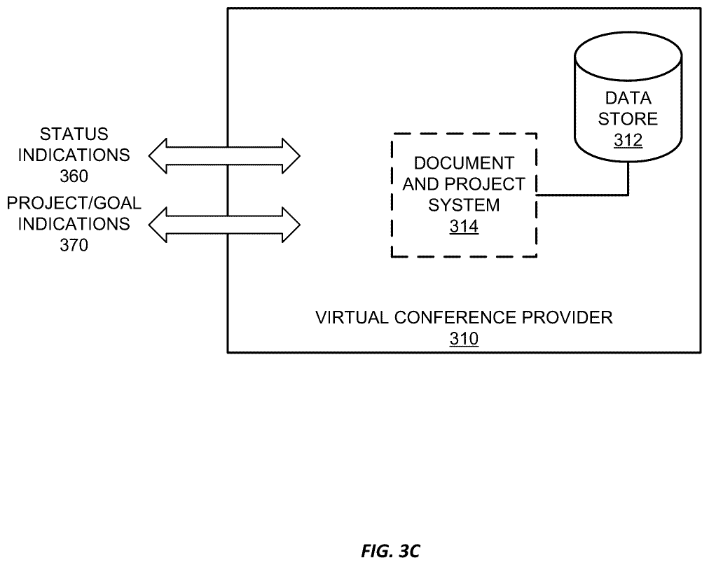

Referring now to FIG. 3A, FIG. 3A shows an example system 300 for integrating multiple shared documents. The system 300 shown in FIG. 3A includes a virtual conference provider 310 that has established and maintains multiple documents 350. The system 300 also includes multiple client devices 330, 340a-n that are connected to the virtual conference provider 310 via a network 320. In this example, the network 320 is the internet; however, any communications network or combination of communications networks may be employed. And while the system 300 is depicted as including multiple client devices 330, 340a-n, it should be appreciated that some example systems may not include any client devices at any particular time. Instead, clients 330, 340a-n can connected to and disconnect from the system 300 at any time.

The virtual conference provider 310 maintains and provides access to various documents 350 and projects 352 stored in a data store 312. To access a document or project, a user, such as the user of client device 330, accesses the virtual conference provider 310, such as by providing access credentials. Once the user has logged in, they may be presented with a graphical user interface (“GUI”) by a client application that allows the user to navigate to the documents or projects available to the user. The documents 350 maintained by the virtual conference provider 310 are accessible via online editing functionality, such as provided by the client application. Because the documents 350 are accessible online via a network connection, but maintained remotely from any client device 330, 340a-n, they may be easily shared between different users. Thus, while the documents 350 discussed in the examples herein are referred to as documents, it should be appreciated that they are shared documents accessible by any users with sufficient access rights.

Referring now to FIG. 3B, FIG. 3B shows a client device 330 that executes a virtual conference client application 360 (or “client application”). The client application 360 provides functionality to enable the user 370 to interact with shared documents 350, such as to view or edit one or more documents 350, or to interact with one or more projects 352. The client application also provides other functionality, such as to join and participate in virtual conferences, as discussed above with respect to FIGS. 1-2, conference scheduling, chat channels, person-to-person voice chats (similar to a conventional telephone call), view contact information of other users, or any other suitable functionality.

To enable user engagement with the various functionality available via the client application 360, the client application 360 interacts with various input and output devices, such as a microphone 332 and camera 334, display 336 and speaker(s) 338, and keyboard 339. The client application 360 can control the microphone 332 and camera 334 to capture audio and video streams to send to the virtual conference provider, the display 336 to present a graphical user interface (“GUI”) for the user 370 to interact with, which may include video output from received video streams, and the speaker(s) 338 to output received audio streams. The user may also use the keyboard 339 to enter chat messages or create or edit documents 350.

Interactions with documents 350 are provided via the document interface 362 provided by the client application 360. This interface 362 provides GUIs to enable various inputs and outputs from and to the user. In addition, the interface 362 interacts with the virtual conference provider 310 to access documents 350 and provide status information about the documents to the virtual conference provider 310. Because the documents 350 are maintained at the virtual conference provider 310 and it mediates access to them, the interface 362 can provide credential information, text or other content entry and display, and identify and display which documents are available to the user.

Similarly, a user may interact with one or more projects via the project interface 364 provided by the client application 360. The project interface 364 may provide a GUI to enable a user to view a project and its associated goals and documents as well as the project's status. The project interface 364 also interacts with the virtual conference provider 310 to obtain project information, including associated goals, documents, and project status. It may also obtain indication information based on the status of one or more documents associated with the project or a goal within the project.

Referring now to FIG. 3C, FIG. 3C shows the virtual conference provider 310, which provides a document and project system 314 for users who interact with documents 350 using their client devices 330, 340a-n. The virtual conference provider 310 authenticates users based on usernames and passwords and, once a user has provided their credentials, the virtual conference provider 310 enables access to documents that the user is authorized to access. Access in this example is mediated by the document and project system 314. When a user uses a client application 360 to access documents, the virtual conference provider 310 can provide identities of the various documents the user has access to, which the client application 360 then displays within a GUI. The user can then select the document of interest and the document and project system 314 provides the requested resources.

In addition to providing access to documents and receiving modifications to those documents, the document and project system 314 receives status indications 360 and tracks the status of some or all of the documents stored in the data store—not all documents may be associated with a particular project or goal. The status is stored in the data store 312 and associated with the corresponding document. A status may be a descriptive status, such as “not started,” “in-progress,” “awaiting approval,” “under review,” “revisions required,” “approved,” or “complete,” or it may be a status indicating a relative level of completion, e.g., 33% complete. Still other status information may be stored according to various examples.

The document and project system 314 also receives project or goal indications 370 associated within one or more documents. As will be discussed in more detail below, users may create projects or goals to be tracked. The projects or goals may be associated with one or more documents 350 stored in the data store 312. In addition, the projects or goals are associated with the corresponding status information for each document associated with the respective project or goal. The document and project system 314 can thus monitor the various status information associated with a project or goal to identify potential delays within the project, such as due to a document that has not yet been started, one that is awaiting approval, or one that requires revisions. Such information can be used by the document and project system 314 to update status information for the project or goal and to generate and provide indications to one or more users associated with the project or goal.

In this example, the document and project system 314 monitors the status of various documents associated with a project or goal and identifies status information that may be delaying progress in the project or goal. For example, a new document may be created and assigned a “not started” status. The document and project system 314 may monitor the status of the new document and, if no content has been added to the document within a threshold period of time of it being created or the “non-started” status has not changed within a threshold period of time, the document and project system 314 may generate and provide an indication to one or more users associated with the document that a delay has been detected. The associated users may be users identified as authors of the document or one or more users identified as a supervisor or team lead. Similar delays may be detected if a document has a “awaiting approval” or “revisions required” status for respective threshold periods of time.

In addition to detecting potential delays based on status information, the document and project system 314 may generate indications to one or more users based on a change in status. For example, the document and project system 314 may generate an indication to one or more users after a new document with a “not started” status is created and the users are associated with it. If a document's status changes to “awaiting approval,” one or more users may be notified of the new status based on their role with respect to the project, e.g., as a supervisor, team lead, or project lead.

Document status may also be used by the document and project system 314 to update a project or goal status. A project or goal may have a completion status associated with it that is based on the status information for the documents associated with the project or goal. For example, each document may be allocated a level of completeness based on its associated status information. For example, a document status of “not started” may have a completeness of 0 or another minimal value, while a document status of “complete” may have a completeness status of 100 or another maximal value. Intermediate status information, such as “in-progress” or“awaiting approval” may have intermediate completeness values, such as 50 or 75. The completeness values for the documents may be combined to generate a completeness value for the project or goal, which may be compared to a maximum potential completeness value for the project or goal. Depending on the completeness value of the project or goal relative to the maximum potential completeness value, the completion status of the project or goal may be updated.

The document and project system 314 may then generate one or more indications based on the progress of the project or goal towards completion. Indications may be generated and provided when reaching certain progress thresholds or if progress stalls for a threshold period of time. For example, if the project does not progress from one threshold to a second threshold within a predetermined period of time, the document and project system 314 may generate and provide an indication of a potential delay to one or more users associated with the project. Still other types of indications may be provided according to various examples.

In addition to tracking project completeness, the document and project system 314 may also allow a project to have goals that are subordinate to the overall project completeness status. For example, users associated with the project may define goals that are associated with one or more documents. Goal status may be tracked similarly to project status, but with the subset of documents associated with the goal, rather than all documents associated with the project. For projects that include subordinate goals, project completeness may be determined based on the relative level of completeness of the various goals alone or in addition to the status of one or more documents associated with the projects.

For example, a user may establish one or more goals associated with a project and assign one or more documents to each of those goals. It should be appreciated that an individual document may be assigned to multiple different goals, according to some examples. The document and project system 314 can then determine the status of each of the goals based on the statuses of the associated documents, generally as described above with respect to determining project completeness. Thus, the different statuses may correspond to percentage completeness for the corresponding documents, which may then be combined to generate a level of completeness for the goal. The completeness levels of the goals may then be combined to generate a level of completeness for the project. For example, if a project has four goals, a user may assign a relative weight to each, or may allow each to be equally weighted. As documents associated with the goals advance through different statuses to completion, the corresponding goal's completion levels may increase over time. These may then be adjusted according to the respective goal's weights and then combined to generate a level of completeness for the project.

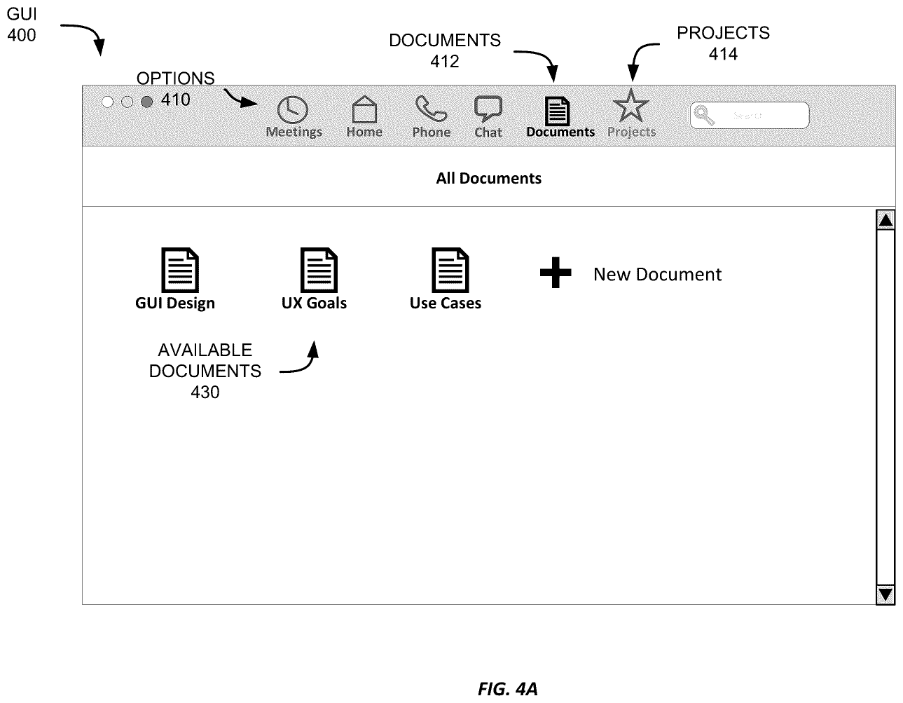

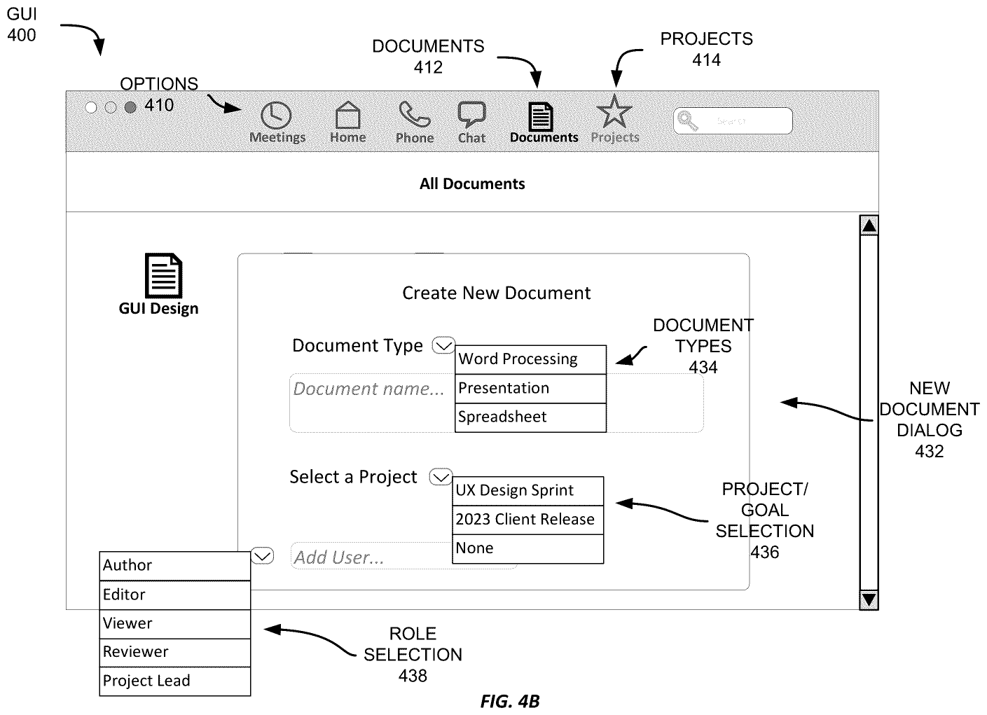

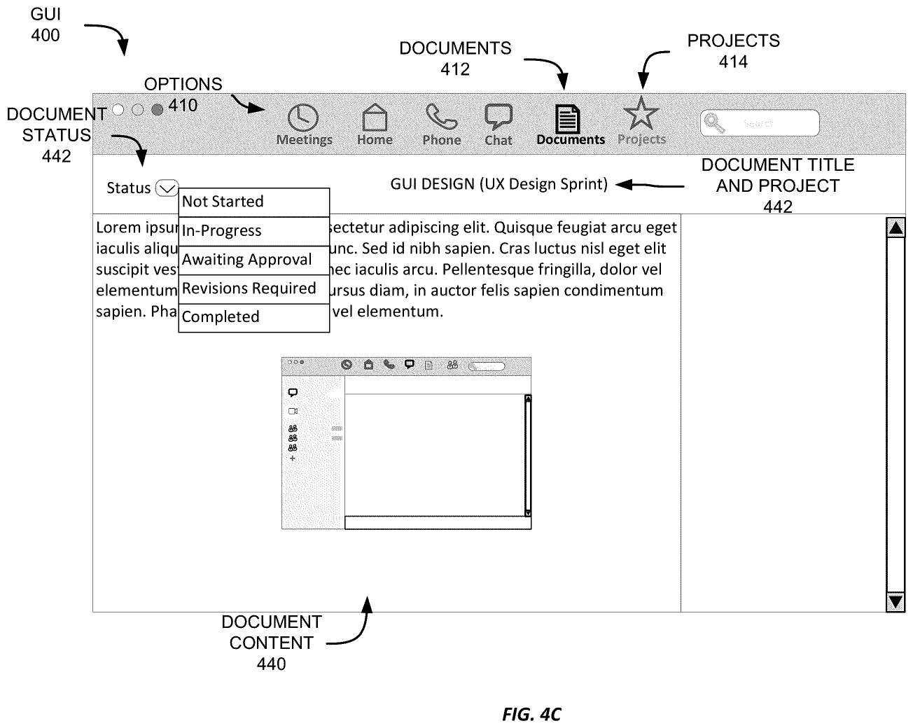

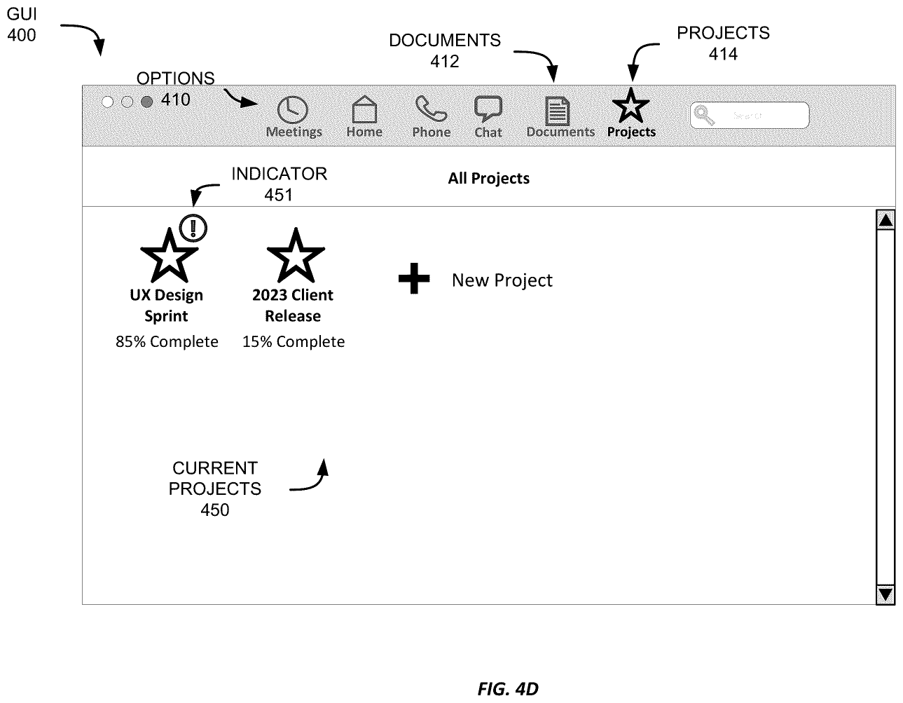

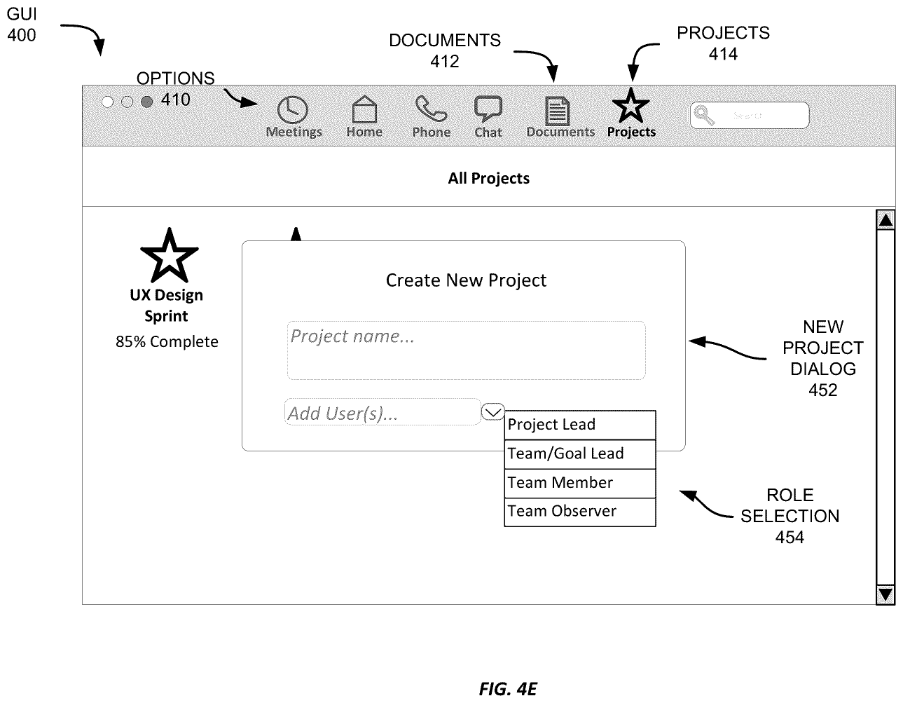

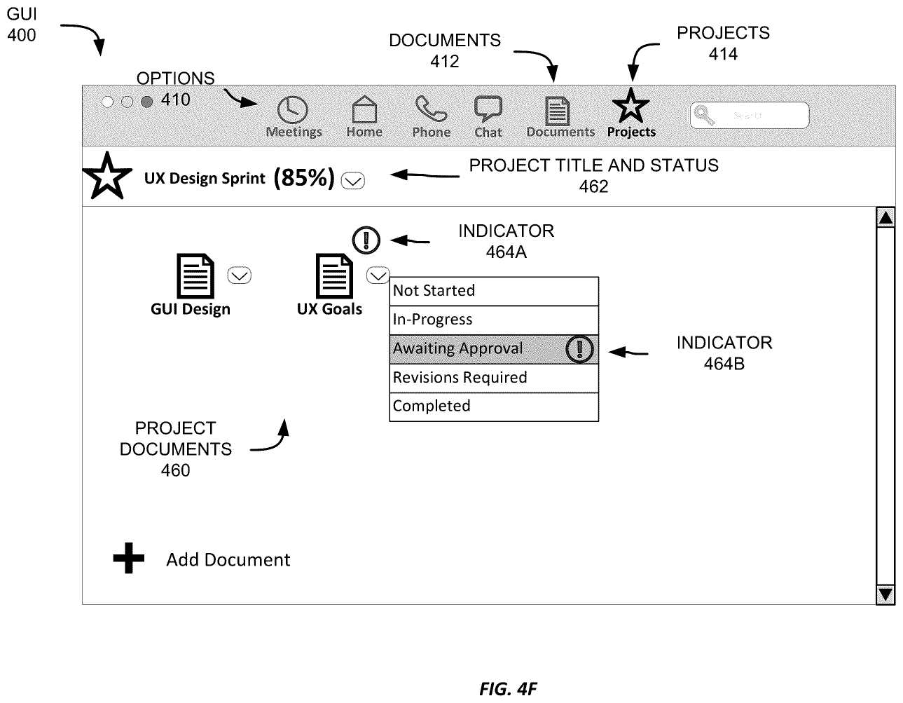

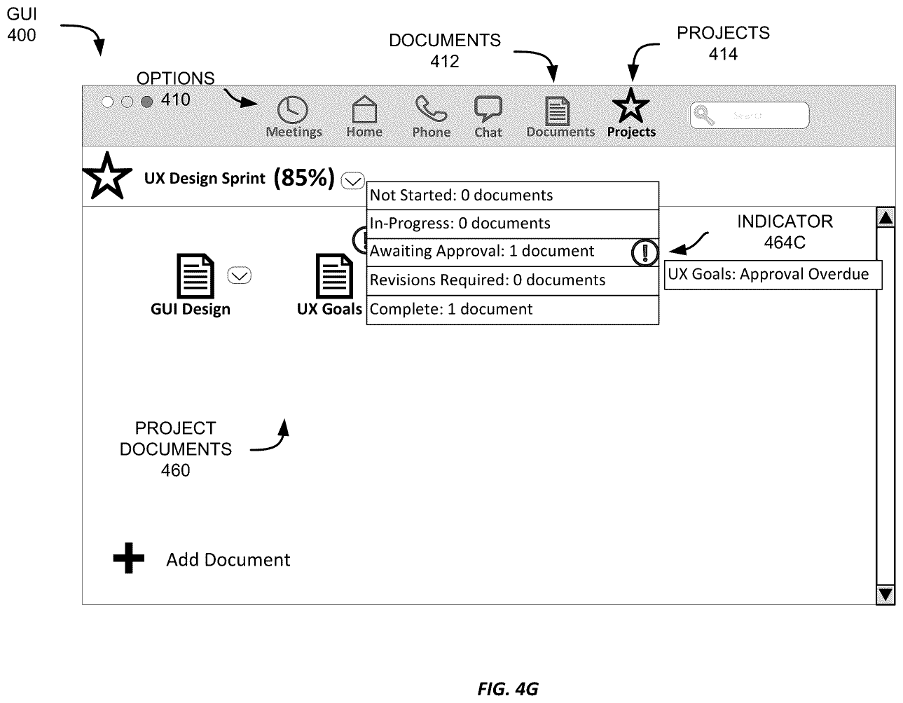

Referring now to FIGS. 4A-4G, FIGS. 4A-4G show different views of a GUI 400 presented by a client application 360. The GUI 400 includes a number of options 410 for different functionality provided by the virtual conference provider 310, including virtual meetings, a user home page, VOIP phone functionality, chat, document editing 412, and the user's projects 414. In the view of the GUI 400 shown in FIG. 4A, the user has selected the documents option 412 and is presented with the various available documents 430 that the user is associated with. In this example, the client application 360 has communicated with the document and project system 314 to obtain a list of all documents accessible by the user. In addition, the GUI 400 allows the user to create a new document by selecting the “New Document” option.

FIG. 4B shows the GUI 400 after the user has selected the “New Document” option, which caused the GUI 400 to display the new document dialog 432. Within the new document dialog 432, the user can enter a name for the document and can select both a document type 434 and a project 436 to associate the document with. In this example, the project/goal selection options 436 include the “UX Design Sprint” project and the “2023 Client Release” project. Alternatively, the user is given the option to specify no project. Finally, the user can identify one or more users who should be associated with the document and specify the user's role 438 with respect to the document.

After selecting appropriate options, the client application 360 sends a request to the document and project system 314 to create the document. The document and project system 314 creates the document and stores it in the data store 312. If the user identified a corresponding project, the document and project system 314 generates and stores an association between the document and the project. Further, if other users are identified as having access to the document, the document and project system 314 creates and stores access rights for the identified users in the data store 312. No status information has yet been provided for the document. Thus, the document and project system 314 may not store a status for the document at the time the document is created, or it may assign a default status, such as “not started” or “in-progress,” which a user can change at another time.

FIG. 4C shows the GUI 400 after the user has opened an existing document associated with a project. The document's title (GUI Design) and the associated project (UX Design Sprint) are shown above the document content 400, which includes both text and graphical content. In addition, the GUI 400 provides the option to establish or update the document's status 442. In this example, five status options are available, though any number of status options may be provided. And while descriptive status options are provided here, other examples may use numeric status information, which may represent a percentage completeness of the document.

As shown in FIG. 4C, the status options are user-selectable and are shared with other users with access to the document. In addition, the selected status is used by the document and project system 314 to generate a project-level completion status and provide notifications to users regarding the document or project. After selecting a status, a message is provided to the document and project system 314, which creates or updates a status corresponding to the document in the data store 312. The document and project system 314 also updates the status of any corresponding project and determines whether to provide one or more notifications based on the status change, which will be discussed in more detail below.

FIG. 4D shows a different view of the GUI 400 where the user has selected the projects option 414. The GUI 400 shows the user a view of all projects that the user is associated with. In this example, the client application 360 communicates with the document and project system 314 to obtain information about the projects that the user is associated with. In this case, the user is associated with two projects: a UX Design Sprint project and a 2023 Client Release project, which are displayed in the GUI 400. In addition, the GUI provides the user with an option to create a new project.

The GUI 400 in this example shows the various projects the user is associated with as well as the current completion status of each project, which is based on the document status information for the various documents associated with the particular project. The GUI 400 also provides an indicator 451 corresponding to the UX Design Sprint project, which is based on status information for one or more documents associated with the project. The project information from the document and project system 314 also includes project completion status, if available, which may then be displayed in the GUI 400. In this case, the UX Design Sprint project is 85% complete, while the 2023 Client Release project is 15% complete, and the status information is displayed adjacent to a graphical representations of the respective projects. If the user would like see more detailed status information for the project, they may select the project of interest.

FIG. 4E shows a view of the GUI 400 after the user has selected the option to create a new project, which causes the GUI 400 to display a new project dialog 452. The user can then supply a name for the project, identify one or more users to associate with the project, and identify roles for each of the users. After the project has been created, a user can identify one or more documents to associate with the project. Though, it should be appreciated that one or more documents can be associated with the project when it is created.

FIG. 4F shows a view of the GUI 400 after the user has selected to view the UX Design Sprint project from the list of projects shown in FIG. 4D. After receiving a selection of the project, the client application 360 requests the list of documents associated with the selected project from the document and project system 314. The document and project system 314 obtains document information from the data store 312 for documents associated with the user, including document types, document titles, and document status information. After receiving the document information, the client application 360 displays the project documents 460. In addition to showing the available documents, the GUI 400 also shows the project's title and status 462 based on the information received from the document and project system 314, which in this case is 85% complete.

In addition to showing the project documents 460, the GUI 400 also shows an indicator 464a adjacent to the document to indicate a potential issue with the document that the user may be able to resolve. To view the reason for the indicator 464a, the user may select the indicator 464a itself or they may select a dropdown option to view the current document status, where a second indicator 464b is displayed adjacent to the current document status, which is highlighted. In this example, the document is awaiting approval. If the user is the assigned reviewer, the user can address the issue by reviewing the document and updating the status. If the user is the document author and is awaiting approval, they can follow-up with the appropriate reviewer.

In this example, the indicators 464a-b are provided to the user because the user has been assigned a role, as shown in FIG. 4B, as either an author, reviewer, or project lead for the document. However, other users that have different roles may not be presented with the indicators 464a-b. Such an example may allow users to only see indicators 464a-b for documents where they can take steps to resolve the corresponding issue.

FIG. 4G shows another view of the GUI 400, similar to the view shown in FIG. 4F. However, in this example, the user has selected a dropdown option to view more detailed status information about the project. The dropdown option allows the user to view summary information about the various documents associated with the project. In addition, the dropdown provides an indicator 464c identifying that at least one of the documents has a potential issue to be resolved. The user can then select the indicator to view the document or documents with the potential issues. In this case, the GUI 400 provides a detailed view of the indicator 464c to identify the document, “UX Goals,” and the potential issue, “Approval Overdue.” While the example here only includes two documents, in projects having a large number of documents, such functionality may enable a user to quickly find documents with associated issues for resolution.

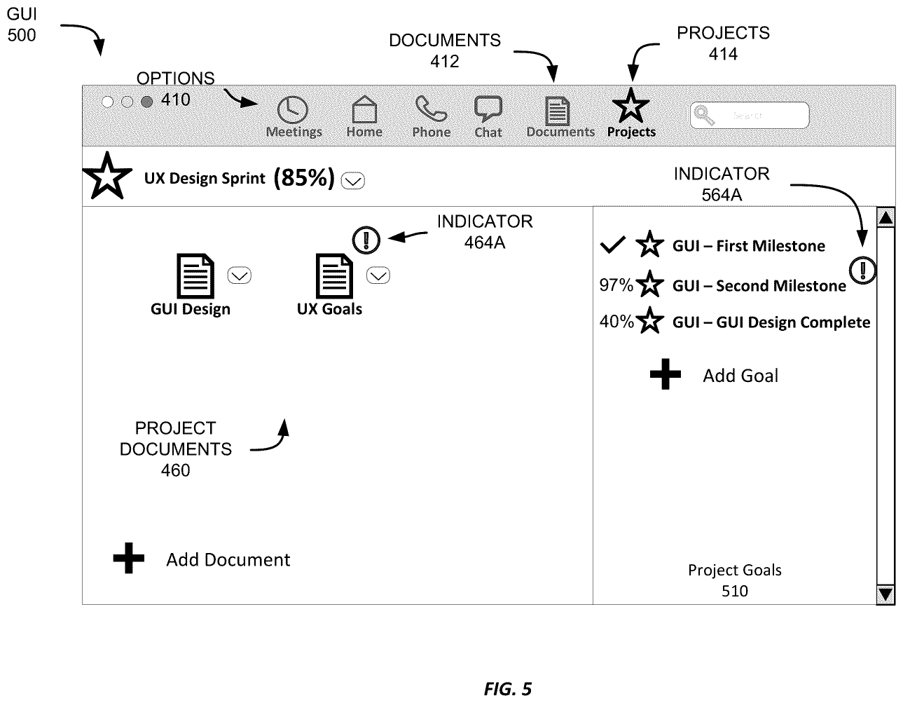

Referring now to FIG. 5, FIG. 5 shows another example GUI 500 that is similar to the GUI 400 shown in FIGS. 4A-4G. However, GUI 500 provides project goals 510 in addition to the project-level completeness status discussed above. Thus, a user can add one or more goals to a project to help track project progress for specific aspects of the project. Such aspects may relate to different teams working on the project or different functionality within the project. Alternatively, the goals may represent progressions from the beginning of the project through certain milestones. The goals may be assigned as described above with respect to FIG. 3C, using the GUI 500 provided by the client application 360 to create goals and to assign documents to one or more of the goals. A user may then select a goal to view the corresponding goal's level of completion.

In some examples goals may be used to group related documents rather than representing a discrete goal of the project. For example, a group of documents may be used to define a GUI, some documents may include mockups, some may describe the specifications of the GUI, while others may include user experience tests and metrics. Thus, the related documents can be grouped together within a goal and their collective status may be obtained as discussed above.

In addition, as discussed above with respect to documents, indicators may be applied to goals. For example, a document may have a corresponding indicator 464a, as discussed above with respect to FIG. 4F. Thus, a goal that include sthe document may also have an associated indicator 564a based on the status of one or more documents associated with the goal, generally as described above with respect to FIGS. 4D and 4G.

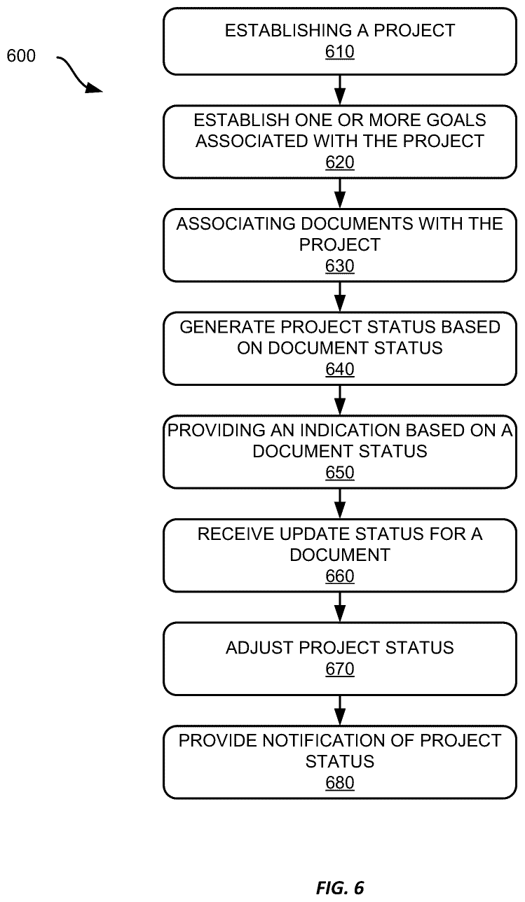

Referring now to FIG. 6, FIG. 6 shows an example method 600 for integrating multiple shared documents. The example method 600 will be described with respect to the system shown in FIGS. 3A-3C and the GUIs 400-500 shown in FIGS. 4A-F and 5; however, any suitable system or GUI may be employed according to this disclosure.

At block 610, the virtual conference provider 310 establishes a new project. For example a user may select an option in a GUI 400 to create a new project. The virtual conference provider 310 then stores records associated with the project within the data store 312. In addition, the virtual conference provider 310 associates one or more users with the project. For example, the user who creates the project may identify one or more users to associate with the project and to assign roles to each.

At block 620, the virtual conference provider 310 establishes one or more goals associated with the project. As discussed above with respect to FIG. 5, a user may select an option to add a goal to the project. However, it should be appreciated that such goals are optional and may be omitted in some examples.

At block 630, the virtual conference provider 310 associates one or more documents with the project. For example, a user may identify one or more existing documents to associate with the project using the client application 360 or the user may create one or more documents to associate with the project, such as discussed above with respect to FIGS. 4A-4B. In addition to associating documents with the project itself, if a user has defined one or more goals associated with the project, such as shown in the GUI 500 of FIG. 5, the user may also associate one or more documents with one or more of the goals. Moreover, a user may associate a document with a goal, which thereby associates the document with the project. The association may then be communicated to the virtual conference provider 310 where the document and project system 314 stores the association(s) within the data store 312.

At block 640, the virtual conference provider 310 generates a project or goal status based on the statuses of the documents associated with the project or goal and can display the status within a GUI 400, 500 provided by a client application 360. As discussed above with respect to FIG. 3C, the virtual conference provider 310 employs a document and project system 314 to generate a project status. As discussed above, each document's status feeds into the project's status. Thus, each document contributes a share of the project's status. By default, the share may be based on the total number of documents divided into 100, though a respective document's share may be manually selected.

A document's status may correspond to a level of completeness for the document, such “not started” may corresponding to a level of completeness of 0, while an “in-progress” status may correspond to a level of completeness of 50. A document's contribution to the overall progress of the project may be determined by assigning a value based on the document's status and its share of the project's status. For example, if the document contributes a 4% share of the project's status, and its status corresponds to a value of 50, the document may contribute 2 points to the project status. The project's status may then be determined by the number of points contributed by each document from a maximum number of possible points from the various documents. This maximum may be normalized to 0-100% or it may be presented as a number of points out of a maximum number of points, e.g., 175 of 550 points.

While the example above has been made with respect to a project status, the document and project system 314 can also update goal statuses using a similar approach. As discussed above with respect to FIG. 5, a user can establish goals within a project and assign documents to the goals. Goal status can then be determined based on the respective statuses of the documents associated with the goal generally as discussed above with respect to determining a project status based on document statuses.

In addition, when a project includes one or more goal, a goal may be treated similarly to a document with respect to its contribution to the project's level of completion. For example, a goal may be assigned a share of the project's level of completion. Thus, to determine the project's level of completion, the goal's contribution may be based on the goal's status, which is determined as discussed above. Thus, document status may flow through to a goal or to a project, and goal status may further be used to determine a project's level of completion.

At block 650, the document and project system 314 provides an indication based on a document status. As discussed above with respect to FIGS. 4D, 4F-G, and 5, the client application 360 outputs indicators 451, 464a-c, 564a based on a document status, which in those examples corresponded to a status of “Awaiting Approval” that had not changed after a threshold period of time, e.g., a week. The document and project system 314 determines whether a status associated with a document should trigger an indication, such as based on a change in status or having a status for an extended period of time.

For example, the document and project system 314 may output an indicator visible to one or more users based on a change in status from “in-progress” to “awaiting approval.” The indicator may be provided to users responsible for reviewing the particular document, such as a team lead or a project lead. Similarly, the document and project system 314 may output an indicator to one or more users based on a change in status from “awaiting approval” to another status, such as “revisions required” or “completed.” The indicators may be provided to one or more users identified as authors of the document, if revisions are needed, or to a project lead, if the document is completed. Still other status transitions may cause one or more indicators to be output.

Alternatively, if a document has had a particular status for a predetermined period of time, it may indicate that an issue needs to be addressed. For example, if a document has a “not started” status, the document and project system 314 may output an indication to one or more authors of the document and to one or more reviewers, the team lead, or the project lead. Such an indication may be used to output an indicator 451, 462a-c to remind the authors to begin working on the document or it may be used by the team or project lead to determine whether the document should be removed from the project. Similarly, if a document has a status of “awaiting approval” or “revisions required” for at least a threshold period of time, the document and project system 314 may output an indication to one or more users that the required task is taking an excessively long time to complete.

At block 660, the document and project system 314 receives an updated status for a document. For example, a user may select a status for a document using the GUI 400, 500. In some examples, the client application 360 may autonomously change a status of a document. For example, a new document may be created and have a “not started” status. If a user begins to edit the document, the client application 360 may autonomously change the status to “in-progress.”

At block 670, the document and project system 314 adjusts the project status based on the updated document status. In this example, the document and project system 314 generates a new project status generally as described above with respect to block 640.

At block 680, the document and project system 314 provides a notification of project status in response to the project status reaching a threshold. For example, the document and project system 314 may output a message to a project lead that the project status has reached a threshold. For example, when a project's completion level reaches 50%, the document and project system 314 may generate a output a chat message to the project lead indicating that the project is 50% complete. Similarly, the document and project system 314 may output a notification to all of the users associated with the project to let them know that the project is 50% complete. Multiple thresholds may be created and used and provide different types of messages or notifications. For example, a threshold at 100% completion may be established and the document and project system 314 may output an urgent message to the project lead or to another person in the organization, such as a CEO or vice president, to notify them that the project is completed. Such messages may be emails, text messages, chat messages, etc.

The discussion of the method 600 above has assumed a particular order of operation, though no such order is required. Moreover, one or more blocks may be omitted in some examples. For example, project goals may not be employed in some examples. Thus, block 620 may be omitted.

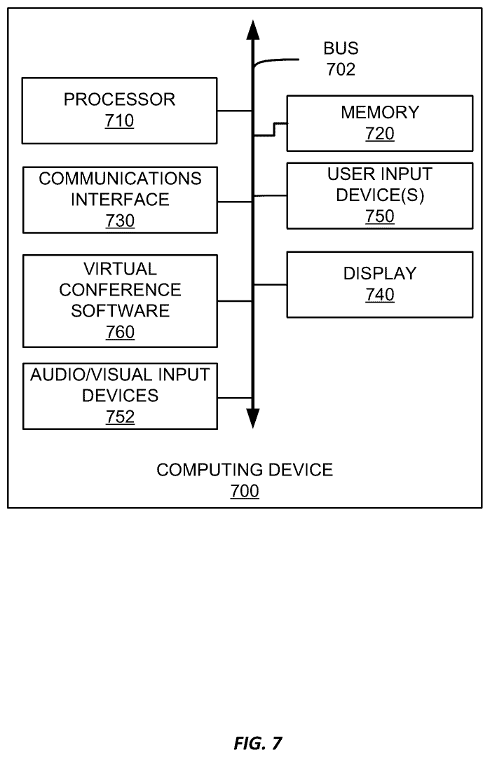

Referring now to FIG. 7, FIG. 7 shows an example computing device 700 suitable for use in example systems or methods for integrating multiple shared documents according to this disclosure. The example computing device 700 includes a processor 710 which is in communication with the memory 720 and other components of the computing device 700 using one or more communications buses 702. The processor 710 is configured to execute processor-executable instructions stored in the memory 720 to perform one or more methods for integrating multiple shared documents according to different examples, such as part or all of the example method 600 described above with respect to FIG. 6.

The computing device, in this example, also includes one or more user input devices 750, such as a keyboard, mouse, touchscreen, microphone, etc., to accept user input. The computing device may also include one or more audio or visual input devices, such as a camera and a microphone, or one or more ports to receive audio or video feeds from an external device, such as a camera, video player, etc. The computing device 700 also includes a display 740 to provide visual output to a user. In some examples, the computing device 700 may operate as a client device, but computing devices according to FIG. 7 may be employed by the virtual conference provider 310 and the virtual conference software 760 may provide a document and project system 314.

While some examples of methods and systems herein are described in terms of software executing on various machines, the methods and systems may also be implemented as specifically-configured hardware, such as field-programmable gate array (FPGA) specifically to execute the various methods according to this disclosure. For example, examples can be implemented in digital electronic circuitry, or in computer hardware, firmware, software, or in a combination thereof. In one example, a device may include a processor or processors. The processor comprises a computer-readable medium, such as a random access memory (RAM) coupled to the processor. The processor executes computer-executable program instructions stored in memory, such as executing one or more computer programs. Such processors may comprise a microprocessor, a digital signal processor (DSP), an application-specific integrated circuit (ASIC), field programmable gate arrays (FPGAs), and state machines. Such processors may further comprise programmable electronic devices such as PLCs, programmable interrupt controllers (PICs), programmable logic devices (PLDs), programmable read-only memories (PROMs), electronically programmable read-only memories (EPROMs or EEPROMs), or other similar devices.

Such processors may comprise, or may be in communication with, media, for example one or more non-transitory computer-readable media, that may store processor-executable instructions that, when executed by the processor, can cause the processor to perform methods according to this disclosure as carried out, or assisted, by a processor. Examples of non-transitory computer-readable medium may include, but are not limited to, an electronic, optical, magnetic, or other storage device capable of providing a processor, such as the processor in a web server, with processor-executable instructions. Other examples of non-transitory computer-readable media include, but are not limited to, a floppy disk, CD-ROM, magnetic disk, memory chip, ROM, RAM, ASIC, configured processor, all optical media, all magnetic tape or other magnetic media, or any other medium from which a computer processor can read. The processor, and the processing, described may be in one or more structures, and may be dispersed through one or more structures. The processor may comprise code to carry out methods (or parts of methods) according to this disclosure.

The foregoing description of some examples has been presented only for the purpose of illustration and description and is not intended to be exhaustive or to limit the disclosure to the precise forms disclosed. Numerous modifications and adaptations thereof will be apparent to those skilled in the art without departing from the spirit and scope of the disclosure.

Reference herein to an example or implementation means that a particular feature, structure, operation, or other characteristic described in connection with the example may be included in at least one implementation of the disclosure. The disclosure is not restricted to the particular examples or implementations described as such. The appearance of the phrases “in one example,” “in an example,” “in one implementation,” or “in an implementation,” or variations of the same in various places in the specification does not necessarily refer to the same example or implementation. Any particular feature, structure, operation, or other characteristic described in this specification in relation to one example or implementation may be combined with other features, structures, operations, or other characteristics described in respect of any other example or implementation.

Use herein of the word “or” is intended to cover inclusive and exclusive OR conditions. In other words, A or B or C includes any or all of the following alternative combinations as appropriate for a particular usage: A alone; B alone; C alone; A and B only; A and C only; B and C only; and A and B and C.

That which is claimed is:

1. A method comprising:
associating a plurality of documents with a project, each document of the plurality of document having an associated status;
generating a project status based on the status of each document of the plurality of documents;
receiving an updated status of a first document;
adjusting the project status based on the updated status; and
in response to the updated project status meeting a threshold, providing a notification of the project status.

2. The method of claim 1, further comprising:
receiving a selection of a goal;
associating the goal with the project;
identifying one or more documents of the plurality of documents associated with the goal; and
updating the goal based on statuses associated with the identified one or more documents.

3. The method of claim 2, wherein adjusting the project status is further based on the updated goal.

4. The method of claim 1, wherein the status is one of not started, in progress, awaiting approval, or complete.

5. The method of claim 1, wherein the notification comprises an identification of one or more documents having a “not started” or “awaiting approval” status.

6. The method of claim 5, wherein the notification is provided to one or more authors associated with the “not started” status.

7. The method of claim 5, wherein the notification is provided to one or more reviewers associated with the “awaiting approval” status.

8. A system comprising:
a non-transitory computer-readable medium;
a communications interface; and
one or more processors communicatively coupled to the non-transitory computer-readable medium and the communications interface, the one or more processors configured to execute processor-executable instructions stored in the non-transitory computer-readable medium to:
associate a plurality of documents with a project, each document of the plurality of document having an associated status;
generate a project status based on the status of each document of the plurality of documents;
receive an updated status of a first document;
adjust the project status based on the updated status; and
in response to the updated project status meeting a threshold, provide a notification of the project status.

9. The system of claim 8, wherein the one or more processors are configured to execute further processor-executable instructions stored in the non-transitory computer-readable medium to:
receive a selection of a goal;
associate the goal with the project;
identify one or more documents of the plurality of documents associated with the goal; and
update the goal based on statuses associated with the identified one or more documents.

10. The system of claim 9, wherein adjusting the project status is further based on the updated goal.

11. The system of claim 8, wherein the status is one of not started, in progress, awaiting approval, or complete.

12. The system of claim 8, wherein the notification comprises an identification of one or more documents having a “not started” or “awaiting approval” status.

13. The system of claim 12, wherein the notification is provided to one or more authors associated with the “not started” status.

14. The system of claim 12, wherein the notification is provided to one or more reviewers associated with the “awaiting approval” status.

15. A non-transitory computer-readable medium comprising processor-executable instructions configured to cause a processor to:
associate a plurality of documents with a project, each document of the plurality of document having an associated status;
generate a project status based on the status of each document of the plurality of documents;
receive an updated status of a first document;
adjust the project status based on the updated status; and
in response to the updated project status meeting a threshold, provide a notification of the project status.

16. The non-transitory computer-readable medium of claim 15, further comprising processor-executable instructions configured to cause the one or more processors to:
receive a selection of a goal;
associate the goal with the project;
identify one or more documents of the plurality of documents associated with the goal; and
update the goal based on statuses associated with the identified one or more documents.

17. The non-transitory computer-readable medium of claim 15, wherein the status is one of not started, in progress, awaiting approval, or complete.

18. The non-transitory computer-readable medium of claim 15, wherein the notification comprises an identification of one or more documents having a “not started” or “awaiting approval” status.

19. The non-transitory computer-readable medium of claim 18, wherein the notification is provided to one or more authors associated with the “not started” status.

20. The non-transitory computer-readable medium of claim 18, wherein the notification is provided to one or more reviewers associated with the “awaiting approval” status.
